(19) United States
(12) Patent Application Publication
(10) Pub. No.: US 2010/0127515 A1
(43) Pub. Date: May 27, 2010

(54) PORTABLE ELECTRONIC DEVICE

(75) Inventor: HUNG-CHEN WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/512,390

(22) Filed: Jul. 30, 2009

(30) Foreign Application Priority Data
Nov. 26, 2008 (CN) 200810305760.8

(51) Int. Cl. E05C 19/00

(52) U.S. Cl. 292/303

(57) ABSTRACT

A portable electronic device includes a main housing, a moveable housing, and a latching member. The main housing defines a latching groove. The movable housing is slidably positioned on the main housing. The latching member is positioned on the movable housing. When the portable electronic device is nested, the latching member the latching groove such that the movable housing and the main housing are fixed together.

### BACKGROUND

1. Technical Field

The present disclosure relates to a portable electronic device.

2. Description of the Related Art

A sliding-housing telephone generally includes a main housing, a movable housing, and a connecting the movable housing to the main housing. The slidable structure allows the main housing and the movable housing to be nested when carried and extended by sliding them apart in a longitudinal direction when in use.

The slidable structure generally includes a stationary plate fixed on the main housing and a slidable plate fixed on the movable housing to engage the stationary plate. The slidable plate is generally longer than the stationary plate. Therefore, the movable housing is unable to snugly engage the main housing when the portable electronic device is nested because an end of the slidable plate is not constrained by the stationary plate.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 is an isometric view of an exemplary embodiment of a portable electronic device in an open state.

FIG. 2 is an exploded, isometric view of the portable electronic device in FIG. 1.

FIG. 3 is an enlarged view of the circled portion III in FIG. 2.

FIG. 4 is a cross-section of the portable electronic device taken along line IV-IV in FIG. 1.

FIG. 5 is a cross-section of the portable electronic device in a nested state.

### DETAILED DESCRIPTION

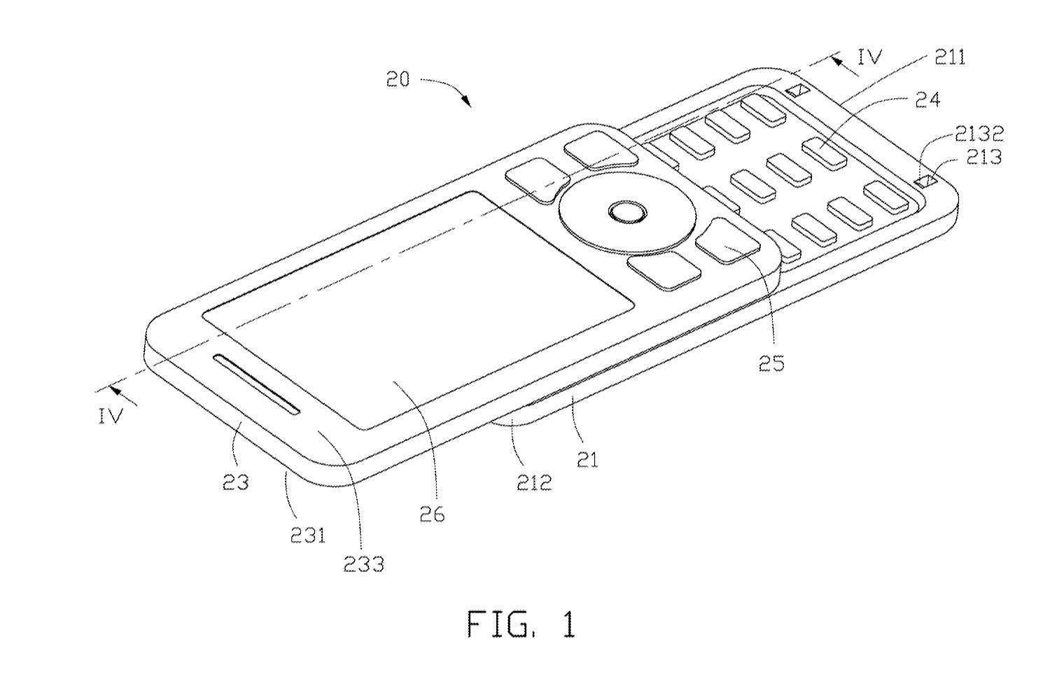

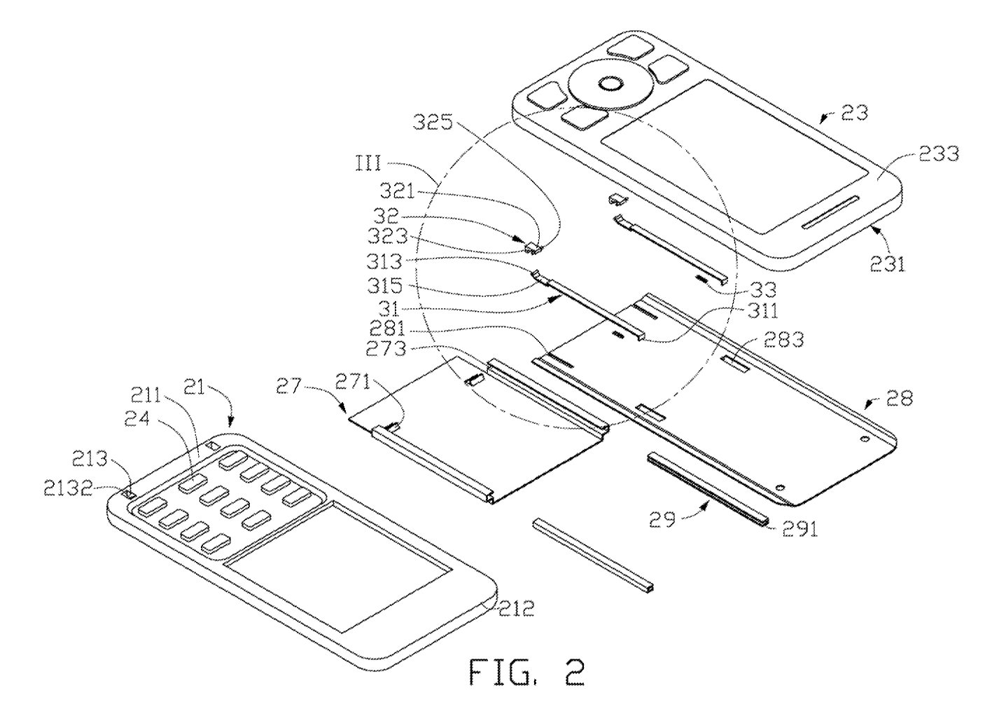

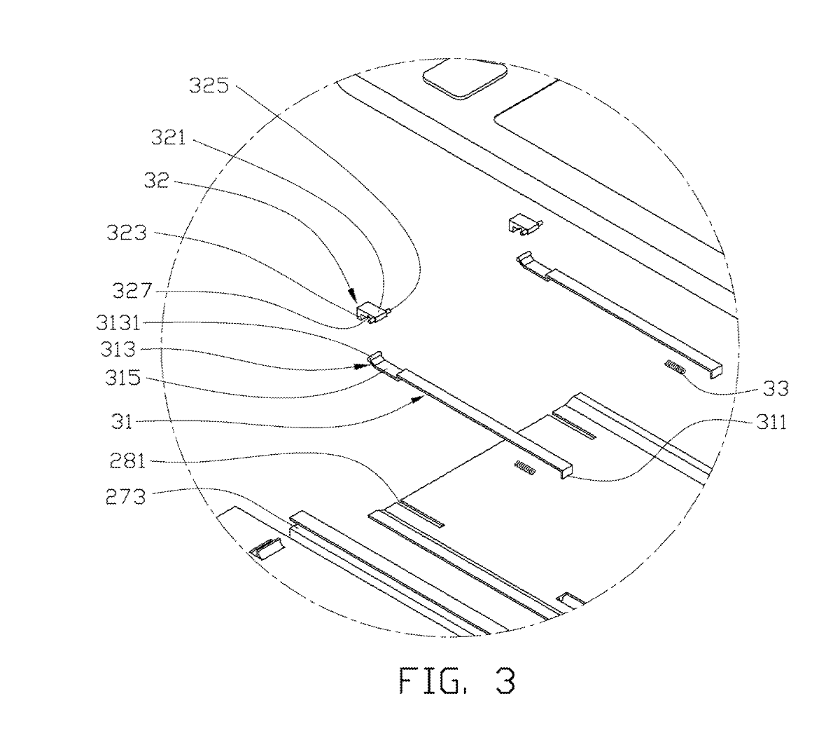

Referring to FIGS. 1 through 3, a portable electronic device 20 includes a main housing 21, a movable housing 23, a keypad 24, a plurality of function keys 25, a display 26, a stationary plate 27, a sliding plate 28, two guide rails 29, two connecting members 31, two latching members 32, and two springs 33.

The main housing 21 includes a first end 211 and a second end 212 opposite to the first end 211. Two adjacent latching grooves 213 are defined in the first end 211 of the main housing 21. Each latching groove 213 is substantially L-shaped. An open end of each latching groove 213 forms a curved sliding surface 2132 adjacent to the second end 212.

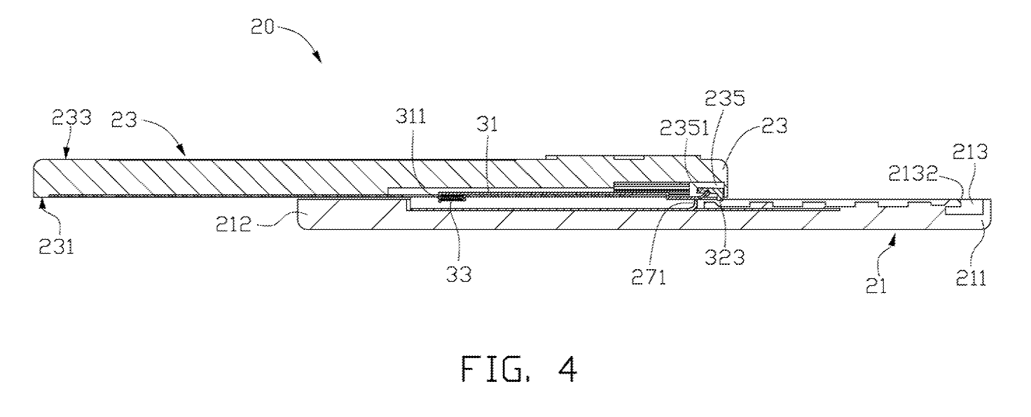

The movable housing 23 includes a first surface 231 and a second surface 233 opposite to the first surface 231. A shape of the movable housing 23 typically corresponds to a shape of the main housing 21. Also referring to FIG. 4, two adjacent depressions 235 are defined in the first surface 231 of the movable housing 23 in an end of the movable housing 23. Opposite sidewalls of each depression 235 define two coaxal pivot holes 2351 respectively.

Two limiting protrusions 271 are formed on the stationary plate 27, and two adjacent receiving grooves 273 are defined in the stationary plate 27 to receive the guide rails 29.

Two adjacent guide slots 281 are defined in an end of the sliding plate 28 to receive a portion of the connecting members 31. Furthermore two adjacent elongated receiving holes 283 are also defined in a middle portion of the slide plate 28 to receive another portion of the connecting members 31. The elongated receiving holes 283 extend along a longitudinal direction of the slide plate 28.

The guide rails 29 are elongated and made of polyxymethylene (POM). Each guide rail 29 defines a slide groove 291 to receive a portion of the sliding plate 28.

Each connecting member 31 forms a resisting end 311 and a connecting end 313 opposite to the resisting end 311. The resisting end 311 extends towards a first direction and the connecting end 313 extends towards a second direction opposite to the first direction. Additionally, each connecting member 31 further forms a connecting portion 315 adjacent to the connecting end 313. The connecting end 313 forms a driving portion 3131. In the illustrated embodiment, the driving portion 3131 is substantially cylindrical.

Each latching member 32 is substantially L-shaped. Each latching member 32 is a hook and includes a first end 321 and a second end 323 opposite to the first end 321. The first end 321 forms a pivot shaft 325 to engage the pivot holes 2351 of the movable housing 23. Furthermore, each latching member 32 defines a depression 327 adjacent to the pivot shaft 325 to engage the driving portion 3131.

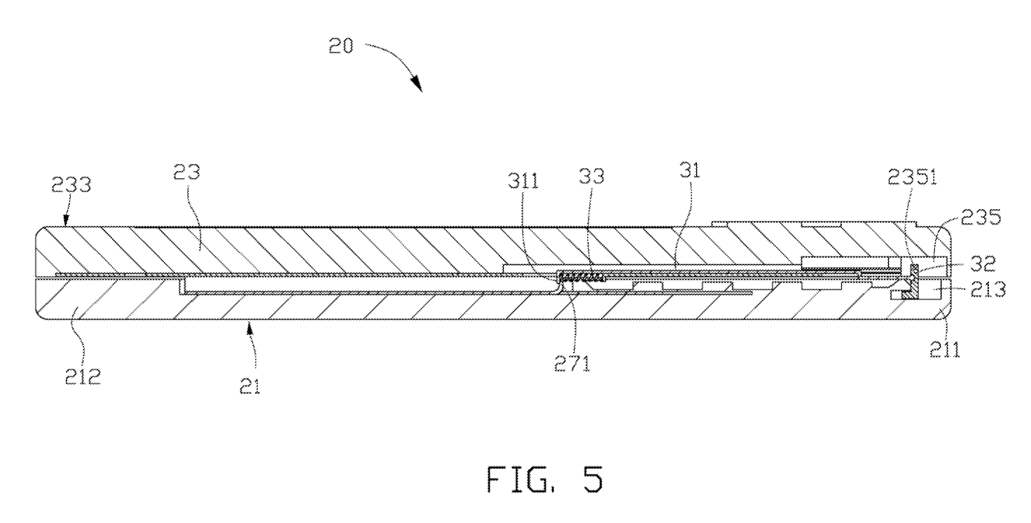

Also referring to FIGS. 4 and 5, during assembly, the stationary plate 27 is fixed on the main housing 21. The guide rails 29 are received in the receiving grooves 273 of the stationary plate 27. The keypad 24 is positioned on the main housing 21 adjacent to the latching grooves 213. The function keys 25 and the display 26 are positioned on the first surface 231 of the movable housing 23.

A portion of the resisting ends 311 of the connecting members 31 passes through the receiving holes 283 of the sliding plate 28 in such manner that the resisting ends 311 of the connecting members 31 engage in the receiving holes 283. One end of each spring 33 is fixed on the resisting end 311 of the corresponding connecting member 31 and another end of each spring 33 is fixed on a periphery of the corresponding receiving hole 283.

The connecting ends 313 of the connecting members 31 engage the guide slots 281 of the sliding plate 28 such that the connecting members 31 are movable along the guide slots 281.

The pivot shafts 325 of the latching members 32 engage the pivot holes 2351 of the movable housing 23 such that the latching members 32 are rotatably positioned in the depressions 235 of the movable housing 23. The driving portions 3131 of the connecting members 31 engage the depressions 327 of the latching members 32 such that the latching members 32 are rotatable relative to the connecting end 313 as shown in FIG. 4.

The sliding plate 28 is fixed on the movable housing 23 such that the connecting members 31 are between the sliding plate 28 and the movable housing 23. A periphery of the sliding plate 28 is latched in the slide grooves 291 of the guide rails 29, thus yielding the portable electronic device 20 as shown in FIG. 1.

When the movable housing 23 is in an open state as shown in FIG. 1, the springs 33 are relaxed, and the second ends 323 of the latching members 32 are adjacent to the limiting protrusions 271 of the stationary plate 27.

A first external force is applied to slide the movable housing 23 to, in turn, move the latching members 32 and the connecting members 31 towards the keypad 24. Simultaneously, the connecting members 31 pull the springs 33 causing deformation thereof. When the resisting ends 311 of the connecting members 31 resist the limiting protrusions 271 of the stationary plate 27, the movable housing 23 stops sliding, thus the portable electronic device 20 is in a nested state as shown in FIG. 5.

In this position, the springs 33 exert a force on the connecting members 31, which rotate the latching members 32 so that the second ends 323 move into and engage the latching grooves 213 of the main housing 21, snugly fixing the movable housing 23 and the main housing 21 together. Since the movable housing 23 is snugly fixed on the main housing 21, a space defined by the movable housing 23 and the main housing 21 is relatively small, the portable electronic device 20 is compact and provides a favorable appearance. Furthermore, the curved sliding surfaces 2132 allow the latching members 32 to be received in the latching grooves 213 of the main housing 21.

To open the portable electronic device 20, a second external force opposite to a direction of the first external force, is applied to slide the movable housing 23. The latching members 32 rotate and detach from the latching groove 213, thereby opening the movable housing 23.

Notely, since the guide rails 29 are polyxymethylene, friction coefficient between the guide rails 29 and the sliding plate 28 is relatively small.

It should be understood that the guide rails 29 can be omitted, in which case two slide grooves 291 are defined in the stationary plate 27.

Finally, while various embodiments have been described and illustrated, the embodiments are not to be construed as being limited thereto. Various modifications can be made to the embodiments by those skilled in the art without departing from the true spirit and scope of the embodiments as defined by the appended claims.

What is claimed is:

1. A portable electronic device comprising:
a main housing defining a latching groove;
a movable housing slidably positioned on the main housing; and
a latching member positioned on the movable housing, wherein when the portable electronic device is nested, the latching member is latched in the latching groove such that the movable housing and the main housing are fixed together.

2. The portable electronic device of claim 1, wherein the latching member is a hook; an end of the latching member forms a pivot shaft; the movable housing defines a depression, a sidewall of the depression defines two opposite pivot holes; and the pivot shaft engages the pivot holes such that the hook is rotatably positioned in the depression.

3. The portable electronic device of claim 2, wherein the hook and the latching groove are substantially L-shaped.

4. The portable electronic device of claim 3, wherein a sidewall of the latching groove forms a curved sliding surface.

5. The portable electronic device of claim 1, further comprising a stationary plate and a sliding plate, wherein the stationary plate is fixed on the main housing, the sliding plate is fixed on the movable housing; and the sliding plate is slidably positioned on the stationary plate.

6. The portable electronic device of claim 5, further comprising two guide rails, wherein the stationary plate defines two receiving grooves to receive the guide rails, each guide rail defines a slide groove, the guide rails are fixed in the receiving grooves, and a periphery of the sliding plate is latched in the slide grooves of the guide rails.

7. The portable electronic device of claim 6, wherein the guide rails are made of polyxymethylene.

8. The portable electronic device of claim 5, further comprising a connecting member comprising a connecting end, and a spring; wherein the connecting end forms a driving portion, the hook defines a depression adjacent to the pivot shaft to engage the driving portion; and the driving portion engages the depression of the hook such that the hook is rotatable to the connecting member.

9. The portable electronic device of claim 8, wherein the sliding plate defines a receiving hole; the connecting member further comprises a resisting end; the resisting end of the connecting member engages the receiving hole of the sliding plate; and one end of the spring is fixed on the resisting end of the connecting member and another end of the spring is fixed on a periphery of the receiving hole.

10. The portable electronic device of claim 9, wherein at least one portion of the resisting end passes through the receiving hole and exposed out of the sliding plate.

11. The portable electronic device of claim 8, wherein the stationary plate forms a limiting protrusion.

12. The portable electronic device of claim 8, wherein the sliding plate defines a guide slot; the connecting member further comprises a connecting portion; the connecting portion engages the guide slot.

13. The portable electronic device of claim 9, wherein the resisting end extends towards a first direction and the connecting end extends towards a second direction opposite to the first direction.

14. A portable electronic device comprising:
a main housing defining two latching grooves therein;
a movable housing slidably positioned on the main housing; and
two latching members positioned on the movable housing, wherein when the portable electronic device is nested, the latching members latch in the latching grooves such that the movable housing and the main housing are fixed together.
